(19) United States
(12) Patent Application Publication
(10) Pub. No.: US 2011/0307933 A1
(43) Pub. Date: Dec. 15, 2011

(54) SYSTEMS AND METHODS FOR IMPLEMENTING SERVER SIDE PUSH MECHANISMS FOR INTERNET PROTOCOL TELEVISION (IPTV) UPDATES

(75) Inventors: Edoardo Gavita, Laval (CA); Erik Nordlund, Montreal (CA); Andre Godin, Laval (CA)

(73) Assignee: TELEFONAKTIEBOLAGET L M ERICSSON (PUBL), Stockholm (SE)

(21) Appl. No.: 12/964,181

(22) Filed: Dec. 9, 2010

Related U.S. Application Data
(60) Provisional application No. 61/355,018, filed on Jun. 15, 2010.

(51) Int. Cl. H04N 7/173

(52) U.S. Cl. 725/112; 725/109

(57) ABSTRACT

Systems and methods provide for transmitting updates in an Internet Protocol Television (IPTV) environment towards a client. The method includes: maintaining the updates in a data hierarchy of updates; receiving a first message identifying a client; retrieving information associated with the client; determining which updates are relevant to the client by matching the information associated with the client to the data hierarchy of updates; and transmitting a second message toward the client with information associated with the determined updates.

### RELATED APPLICATION

This non-provisional patent application is related to, and claims priority based upon, U.S. Provisional Patent Application Ser. No. 61/355,018, filed on Jun. 15, 2010, entitled “Implementing Server Side Push Mechanisms for IPTV Notifications”, the disclosure of which is expressly incorporated here by reference.

### TECHNICAL FIELD

The embodiments of the subject matter disclosed herein generally relates to push and version control mechanisms for use between servers and clients in an Internet Protocol Television (IPTV) environment.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow users to communicate via e-mail, video conferencing, IM, and the like. Mobile telephones have conventionally served as voice communication devices, but through technological advancements they have recently proved to be effective devices for communicating data, graphics, etc. As user demand for seamless communications across different platforms increases, which in turn creates more usage, and leads to more services and system improvements it is expected that wireless and landline technologies will continue to merge into a more unified communication system in support of such demand.

Various systems and methods have been used to deliver and/or request information between devices, nodes and networks. One example of such techniques is known as push technology, or server push, which describes a style of Internet-based communication where the request for a given transaction is initiated by the publisher or central server. Push can be contrasted with pull technologies, where the request for the transmission of information is initiated by the receiver or client.

Push services are often based on information preferences expressed in advance. This is called a publish/subscribe model wherein a client might “subscribe” to various information “channels”. Whenever new content is available on one of those channels, the server would push that information out to the user. Other mechanisms used for information delivery include hypertext transfer protocol (HTTP) push (also known as HTTP streaming), a special Multipurpose Internet Mail Extensions (MIME) type called multipart/x-mixed replace, long polling, XMPP, Bidirectional-streams Over Synchronous HTTP (BOSH) and Web Sockets Application Programming Interface (API) for HTML5.

As one skilled in the art will appreciate, none of these mechanisms is well supported by a plurality of different browsers, and no one current mechanism provides interoperability with all browsers.

One emerging environment for the delivery and requesting of services is Internet Protocol Television (IPTV). IPTV is a system over which IPTV services, e.g., video on demand (VoD) and live television programs, can be delivered over, for example, the Internet and/or broadband Internet access networks. In the IPTV environment, it is desirable for servers to send content information such as an electronic programming guide (EPG) to clients when updates are available. Currently, update information is transmitted from servers to clients after the clients request information during a polling cycle, i.e., a pull mechanism. However, as the quantity of clients increases, various problems and inefficiencies arise when using the polling cycle.

For example, polling by the clients can occur when there are no updates available at the server which is inefficient in terms of bandwidth usage. Also, as the quantity of clients increases, the length of the polling cycle can become so long that a significant amount of delay can occur between the institution of content change at the server and the beginning of a new polling cycle for delivery of the content to the clients. Additionally, negative HTTP cache issues can occur associated with the cache timeout, e.g., an associated delay in service delivery.

Accordingly, systems and methods for improving delivery of, for example, IPTV updates are desirable.

### SUMMARY

Exemplary embodiments describe using server side push functions for delivering update information and/or content information in an Internet Protocol Television (IPTV) environment. By using server side push functions described in the exemplary embodiments described herein in an IPTV environment the limited bandwidth can be used more efficiently.

According to an exemplary embodiment there is a method for transmitting updates in an Internet Protocol Television (IPTV) system towards a client. The method includes: maintaining the updates in a data hierarchy of updates; receiving a first message identifying a client; retrieving information associated with the client; determining which updates are relevant to the client by matching the information associated with the client to the data hierarchy of updates; and transmitting a second message toward the client with information associated with the determined updates.

According to another exemplary embodiment there is another method for transmitting updates in an IPTV system towards a client. The method includes: receiving a first message which includes information associated with an update; determining, based on the information associated with the update, an effect to a first data hierarchy; applying a change to the first data hierarchy based on the effect to the first data hierarchy, which change results in a second data hierarchy which is differentiated from the first data hierarchy by having a different version number; storing the second data hierarchy and its associated version number; determining which clients to notify of the change to the first data hierarchy, which results in a subset of clients to receive update information associated with the second data hierarchy; and transmitting a second message which includes information associated with the second data hierarchy to the subset of clients.

According to another exemplary embodiment there is a method for receiving updates in an IPTV system. The method includes: transmitting, from a client, a first message identifying the client, wherein the first message is a long-held hypertext transport protocol (HTTP) message; receiving a second message, wherein the second message includes a DataReference and a Version for describing available updates for the client; and storing the DataReference and the Version.

According to another exemplary embodiment there is a communications node for transmitting updates in an Internet Protocol Television (IPTV) system towards a client. The communications node includes: a communications interface for receiving a first message identifying a client; a memory from which information associated with the client is retrieved and in which a data hierarchy of updates is maintained; a processor for determining which updates are relevant to the client by matching the information associated with the client to said data hierarchy of updates; and wherein the communications interface transmits a second message toward the client with information associated with the determined updates.

According to another exemplary embodiment there is a communications node for transmitting updates in an Internet Protocol Television (IPTV) system. The communications node includes: a communications node for receiving a first message which includes information associated with an update; a processor for determining, based on the information associated with the update, an effect to a first data hierarchy, wherein the processor also applies a change to the first data hierarchy based on the effect to the first data hierarchy which change results in a second data hierarchy which is differentiated from the first data hierarchy by having a different version number; a memory for storing the second data hierarchy and its associated version number; the processor which also is for determining which clients to notify of the change to the first data hierarchy, which results in a subset of clients to receive update information associated with the second data hierarchy; and wherein the communications interface also is for transmitting a second message which includes information associated with the second data hierarchy to the subset of clients.

According to another exemplary embodiment there is a user equipment (UE) which hosts a client for receiving updates in an Internet Protocol Television (IPTV) system. The UE includes: a communications interface for transmitting a first message identifying the client, wherein the first message is a long-held hypertext (HTTP) message and for receiving a second message, wherein the second message includes a DataReference and a Version for describing available updates for the client; and a memory for storing the DataReference and the Version.

### BRIEF DESCRIPTION OF THE DRAWINGS

The accompanying drawings illustrate exemplary embodiments, wherein:

FIG. 1 depicts an architecture according to exemplary embodiments;

FIG. 2 illustrates more details of the architecture shown in FIG. 1 according to exemplary embodiments;

FIG. 3 shows a visual representation of DataReferences in a hierarchical form according to exemplary embodiments;

FIG. 4 illustrates a two-dimensional array according to exemplary embodiments;

FIG. 5 shows a table for supporting message tracking according to exemplary embodiments;

FIG. 6 illustrates a use case for an application update according to exemplary embodiments;

FIG. 7 illustrates a second use case for an application update according to exemplary embodiments;

FIG. 8 illustrates a communications node according to exemplary embodiments; and

FIG. 9 is a method flow for transmitting updates in an Internet Protocol Television (IPTV) system towards a client according to exemplary embodiments.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As described in the Background section, as the quantity of clients increases in the Internet Protocol Television (IPTV) environment, the currently used method of polling by the clients for requesting and distributing content from servers becomes less efficient, e.g., there is a less efficient use of limited bandwidth. Moreover, there is no centralized mechanism that can be used by a server in an IPTV environment to push one or many notifications out to multiple client equipment (Set-top boxes (STBs)) simultaneously. Furthermore, there is a lack of mechanisms to notify one or multiple STBs (simultaneously) in the IPTV solution when there are content updates, e.g., electronic program guide (EPG) updates, waiting to be downloaded. There is also no convenient mechanism for the IPTV operator to push out mass information towards the bulk of end users/STBs when desired. A further issue is that using either the current polling technique in IPTV or previously mentioned push mechanisms (for other environments) to push data only to the STBs that have not been updated or did not receive the update is not necessarily feasible.

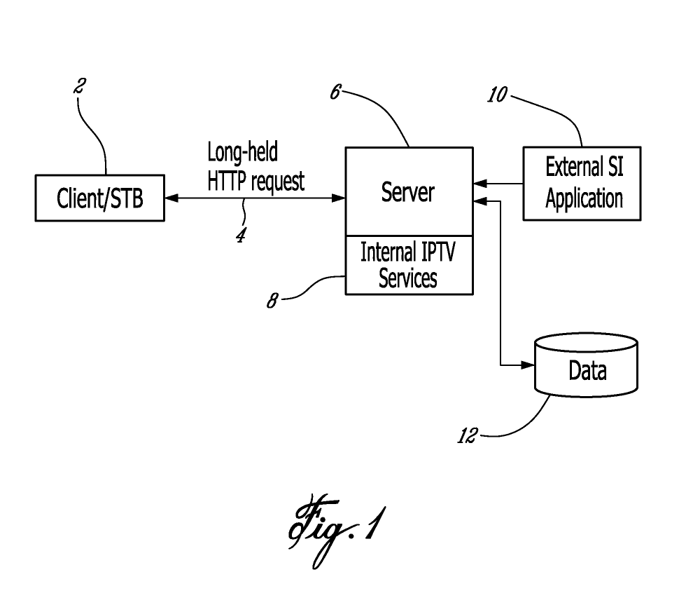

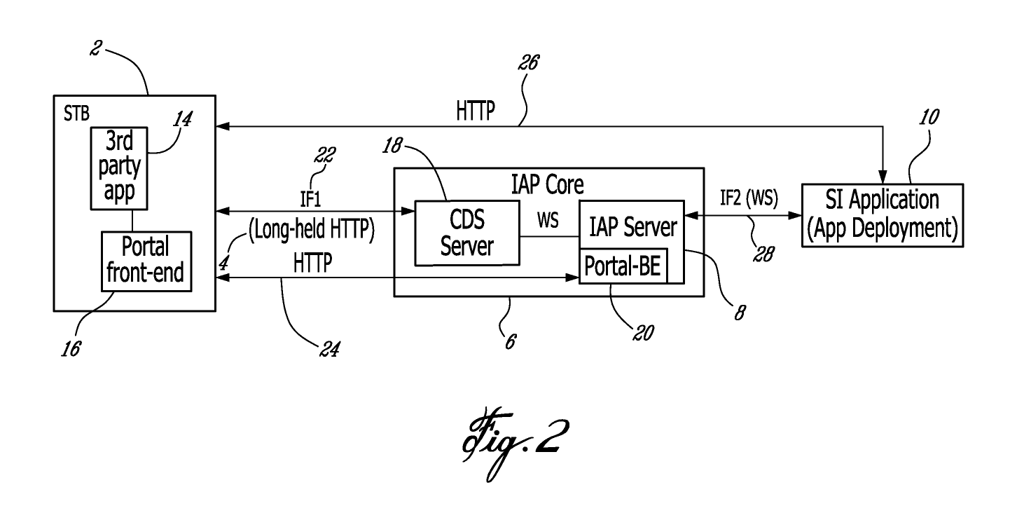

According to exemplary embodiments, methods and systems for pushing information in an IPTV environment which solve the aforementioned issues are described herein. More specifically, exemplary embodiments can use a combination of a long-held hypertext transfer protocol (HTTP) request, a hierarchical representation of a data and a versioning scheme. According to one exemplary embodiment, the combination of a long-held HTTP request allowing an IPTV server to push data to the client, e.g., a portal front-end in an STB, without the client explicitly requesting it, and a hierarchical representation of the reference to the data and versioning scheme, used to help the server to determine what needs to be pushed to the client, can be employed. Prior to describing these exemplary systems and methods, an architecture which supports these exemplary systems and methods is shown in the purely illustrative exemplary architectures of FIGS. 1 and 2.

The exemplary architecture shown in FIG. 1 includes a client which can be on an STB 2, a server 6 which includes (or can be in communications with) IPTV Services 8, an External SI Application 10 and a database 12. According to an exemplary embodiment, the server 6 can be in communications with the STB 2 via a long-held HTTP request 4. The long-held HTTP request 4 can be a persistent or almost persistent connection between a browser client on the STB 2 and a server, e.g., server 6, which can determine when to provide updates associated with an application. The long-held HTTP request 4 supports using a push system in the IPTV environment for the distribution of content and/or content updates as desired either by the client or the operator of the server 6. Internal IPTV Services 8 can provide IPTV services, e.g., an application or updates to content and the like, to the STB 2. External Systems Integration (SI) Application 10 can provide content to the server 6, and the database 12 can be used to store information associated with clients, the clients' preferences, status of updates transmitted and hierarchical data associated with content for use in determining what information the server 6 should push. Additionally, while the client is shown to be on the STB 2, other devices capable of hosting the client, e.g., a laptop, can be used in place of the STB 2 for hosting the client.

According to exemplary embodiments, the exemplary architecture shown in FIG. 2 shows elements of the exemplary architecture described in FIG. 1 in more detail. More specifically, FIG. 2 shows the STB 2, the server 6 and the External SI Application 10 with communication flows that support a server side push mechanisms that are described in more detail below. According to exemplary embodiments, STB 2 can include a 3^{rd} party application 14, e.g., an electronic program guide (EPG), and a portal front-end 16. The portal front-end 16 is in communications with both a Client Distribution Service (CDS) server 18 and the portal back-end 20 associated with the IPTV Application Platform (IAP) server 8. The IAP Core web service (WS) 18 includes both the CDS server 18 and the IAP server 8 both of which are able to communicate with each other. The SI Application 10 is also present which can perform application deployment.

According to exemplary embodiments, the server side push mechanism can use two interfaces, shown in the architecture of FIG. 2, in support of determining what to push and to perform the pushing of messages with or without an attached payload. Interface 1 (IF1) 22 can be used for communications between the portal front-end 16 and the CDS server 18. Using IF1 22, the STB 2, via the portal front-end 16, can send a message to the CDS server 18 detailing which notifications the portal (representing a user) is interested in, e.g., the portal front-end 16 can transmit an HTTP POST message containing java script object notification (JSON) data detailing which notifications are of interest. Additionally, the long-held HTTP request 4 can occur over IF1 22.

According to exemplary embodiments, Interface 2 (IF2) 28 can be used for communications between the IAP server 8 and the SI Application 10. Using IF2 28, the SI Application 10 can send a message request (i.e., change request) to the IAP Server 8 instructing the IAP Server 8 to push a message notification (with or without payload) to the provided list of one or more target recipients (which can be identified as users, subscribers, equipment, or any combination thereof), e.g., transmitting this information to the IAP Server 8 in a pushMessageRequest()message. Additionally, as shown in FIG. 2, the portal back-end 20 has communications link 24, which can be an HTTP link, with the STB 2 and the SI Application 10 has a communications link 26, which can also be an HTTP link, with the STB 2.

According to exemplary embodiments, as described above, the long-held HTTP request 4 can be used in the exemplary architectures shown in FIGS. 1 and 2 in support of pushing information to the STB 2. The long-held HTTP request 4 in conjunction with hierarchical references and versioning scheme allow the server 6, according to this exemplary embodiment, to keep the client waiting until new relevant changes to data arrive at (or are generated by) the server 6, and to push the new change(s) only if the change(s) match some criteria expressed by the client, e.g., (1) what the client interest is (referred to herein as DataReference) and (2) what the Version of the last change the client received for a given DataReference. Additionally, when server 6 pushes a notification without payload, it is a notification indicating which data has changed, not the data itself. STB 2 can then use link 24 or link 26 to fetch the data that has changed.

According to exemplary embodiments, the server 6 and the STB 2 (hosting the client) share a hierarchical model of the data that can be updated. The server 6 tracks changes related to the stored data. Each change of the stored data is then stored and represented by a data couplet composed of the DataReference and a Version.

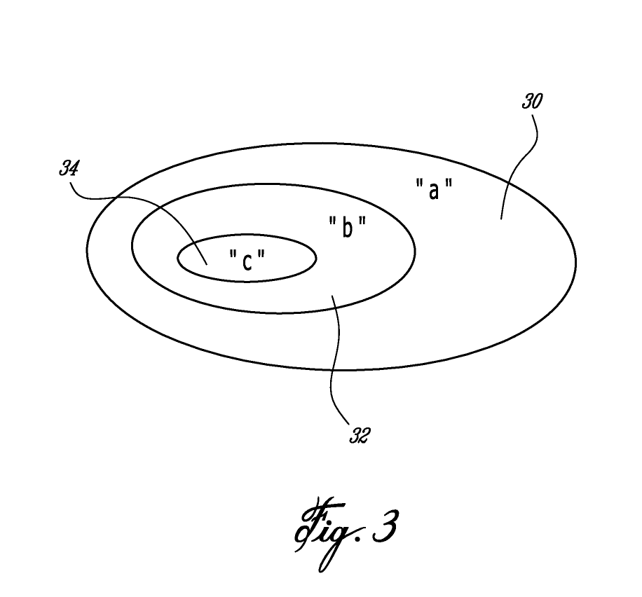

According to exemplary embodiments, the DataReference represents a reference to the data and is preferably expressed in a hierarchical form. A purely illustrative visual representation of DataReferences in a hierarchical form is shown in FIG. 3. Therein, the hierarchy is an ordered list of identifiers which specifies what data has changed. An entity in the hierarchy that is an ancestor of another entity in the hierarchy is said to supersede the newer entity. For example, consider the three entities a 30, b 32 and c 34 shown in FIG. 3. Entity a 30 is shown as a ring shaped area which includes the ring shaped area of entity b 32, both of which include the ring shaped area of entity c 34. Using the hierarchical rules, hierarchy “a.b” supersedes hierarchy “a.b.c”. Accordingly, a change to hierarchy “a.b.c” is also a change to hierarchy “a.b”. As well, a change to hierarchy “a.b” should be considered as a potential change to hierarchy “a.b.c” because there is a possibility that the change also impacts the data referred to by hierarchy “a.b.c”. According to exemplary embodiments, this potential change is evaluated at the server 6 to determine if the change does impact the data referred to by hierarchy “a.b.c” with appropriate actions taken if the change is determined to have made an impact.

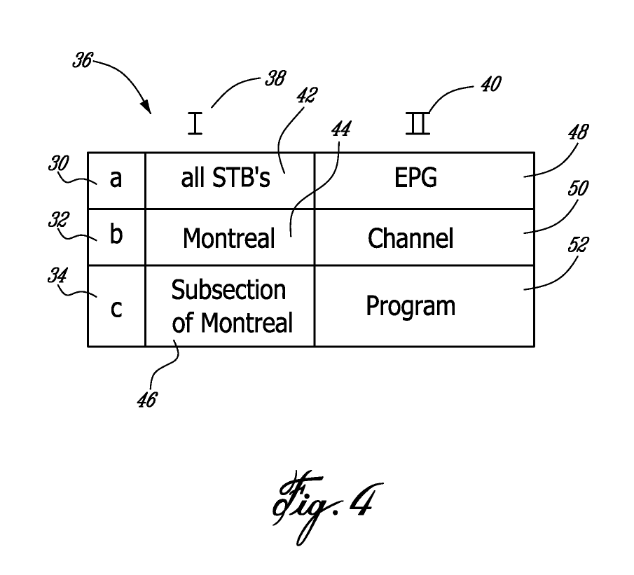

According to exemplary embodiments, the DataReference information can be stored as a multi-dimensional array. An example of a two-dimensional array is shown in FIG. 4, however more or fewer dimensions can be used. Moreover, other forms for storing this data may be used, and the array format should not be considered to be limiting. FIG. 4 shows a two-dimensional array 36 which can be used to describe a 30, b 32 and c 34. Column I 38 includes at the a 30 level “all STBs” 42, at the b 32 level “Montreal” and at the c 34 level “Subsection of Montreal”. Column II includes at the a 30 level “EPG” 48, at the b 32 level “Channel” 50 and at the c 34 level “Program” 52. These columns can be used independent from each other or in combination as desired.

According to an exemplary embodiment, the Version portion of the data couplet is a sequential (but not necessarily consecutive value) that represents the version of the DataReference. When the server 6 generates or receives new changes, the server 6 assigns a Version to the change. The Version can be used to synchronize the client on the STB 2 and the server 6 to the same DataReference Version, e.g., upgrading the client on the STB 2 from DataReference, Version 10 to DataReference, Version 11.

According to exemplary embodiments, the hierarchical form of DataReference allows the server 6 to apply so-called “collapsing rules” to reduce the amount of data sent to the client on the STB 2. Based on the exemplary principles that the server 6 only needs to keep the latest Version of a DataReference stored, and that a DataReference hierarchy that is an ancestor of another DataReference hierarchy is said to supersede it, two rules can be applied. For the first rule, when new data is generated and/or received by the server 6 with a DataReference corresponding to the DataReference of an existing data element, the server 6 can update the existing DataReference of an existing data element and the server 6 can update the existing DataReference with a new Version in the associated data couplet. For the second rule, when new data is generated and/or received by the server 6 with a DataReference that is an ancestor of the DataReference of an existing data, the server 6 can remove those older changes from its list and add a new change for the newly received change.

According to exemplary embodiments, when the client on the STB 2 connects to the server 6, the STB 2 preferably makes use of a long-held HTTP request 4 that includes a list of DataReference and Version pairs (data couplets). The client on the STB 2 then waits for a response from the server 6. The STB 2 will either receive an immediate (or nearly immediate) response from the server 6 if there is at least one relevant pending data update at the server 6, or the STB 2 will receive a response when such an update (or updates) is available.

According to exemplary embodiments, the DataReference can be viewed as an ordered list of strings which identify a data in a hierarchical form. The DataReference matches given data stored in the server 6 if it identifies the same hierarchy, an ancestor, or a descendant of that hierarchy. For example, DataReference [“a”,“b”] matches [“a”], [“a”,“b”] and [“a”,“b”,“c”], but not [“b”] or [“a”,“c”]. When the client on the STB 2 requests data providing a DataReference and a Version, the server 6 can compare the Version of the changes it owns with the Version provided by the client on the STB 2. The server 6 can then return a change to the client on the STB 2 if the version of the DataReference associated with the change is newer than the Version provided by the client on the STB 2.

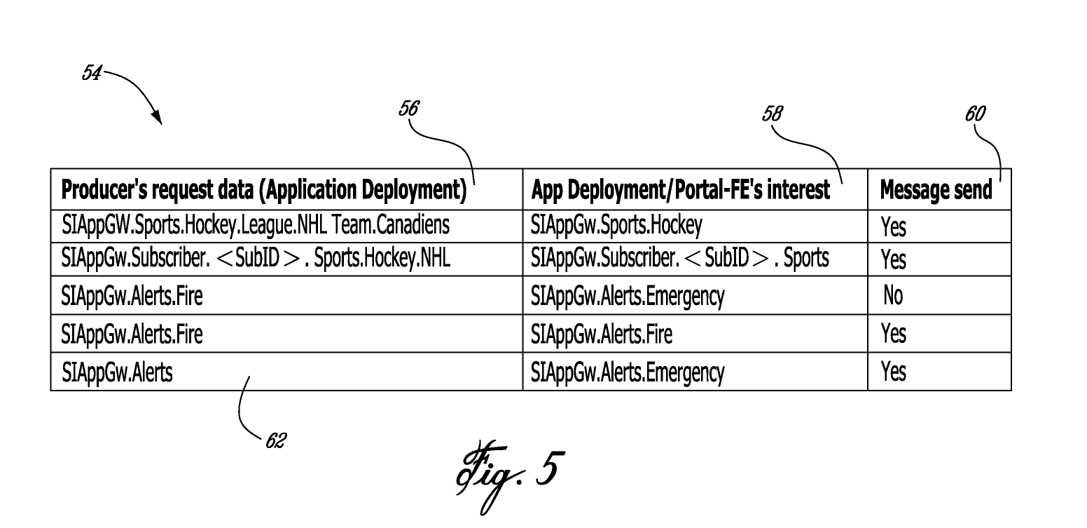

As described above, according to exemplary embodiments, the server side push mechanism can use a hierarchy for notifications of event changes and updates to the client on the STB 2 (or other host device). The hierarchy can ensure that only the STBs 2 which are subscribed to a particular event receive the relevant update. Notification matching rules to group the population and provide group notifications can also be used by the serer 6. Alternatively, the matching can be done on the CDS server 18 which also can ensure that a notification is received only once. A purely illustrative example of a table which can be used to support this matching and tracking is shown in FIG. 5. In FIG. 5 there is a matching table 54 for storing the desired information in a useful fashion. Headers can include a “Producer's request data (Application Deployment” header 56 which describes what is available to be pushed, an “Application Deployment/Portal-FE's interest” header 58 which describes the client on the STB's 2 interest, and a “Message sent” header 60 which tracks the sending of messages to the client on the STB 2. For example, row 62 illustrates that an application deployment for “SIAppGw.Alerts” is desired by the client on the STB 2 and that the message was sent to the STB 2.

According to exemplary embodiments, the server 6 can also return the Version of the change in the response to the client on the STB 2. This returned Version value may then be used by the client on the STB 2 in any following request when reconnecting to the server 6 to ensure that the server 6 will only return changes that the client on the STB 2 has not yet received. If the client on the STB 2 does not provide a Version for a given DataReference, the server 6 can be provided with a default behavior, such as providing all changes matching that DataReference. This supports the case when the client is first initialized and knows nothing about its state with regards to DataReferences (for instance, at startup if the client on the STB 2 does not persistently store data). From this, the client on the STB 2 needs to, at a minimum, provide information identifying itself in order to receive all changes matching the DataReference (or whatever has been pre-stored as a preference associated with the identification for the client on the server 6).

According to exemplary embodiments, from the perspective of the user terminal with the client, such as the STB 2, the long-held HTTP request 4 can be transmitted to the server 6, and the server 6 can be provided with a set of hierarchical DataReference and Version couplets. The client on the STB 2 then enters a waiting state for notifications update information. According to an exemplary embodiment, if a notification is received that indicates that there are desired updates, the STB 2 can pull the updates from an indicated position using link 24 or link 26. According to other exemplary embodiments, one skilled in the art will appreciate that in place of the notification(s) being pushed, the update(s) themselves can be pushed. However, in some exemplary embodiments, it is preferable to push only the notification so that the STB 2 can schedule a pull of the new data, or so that the new data can be pulled in a manner that is preferable to a direct pull from the notification server. Therefore, according to an exemplary embodiment, both push and pull mechanisms can be used in some cases to ensure that the client on the STB 2 receives the current notifications and changes.

According to exemplary embodiments, as described above, the client on the STB 2 can set preferences with server 6 for notifications of interest. These notifications can be described based on the exemplary hierarchical data structures previously described, e.g., as shown in FIGS. 3 and 4. According to an alternative exemplary embodiment a 3^{rd} party application developed and associated with a portal (portal front-end 16 and portal back-end 20) can subscribe to notifications. For example, the application could subscribe to “alert” messages and when a notification is received from the CDS server 18 at the STB 2 with “alert.fire” a notification is sent to the application. The application is then responsible to act on the notification and to make sure to not overload the network if a server request is necessary. Additionally, the application can know the quantity of clients to which the notification was sent and by delaying the server request with, for example, a random time to spread the load in the network from the clients.

According to another exemplary embodiment, from the perspective of the server 6, the server 6 receives a long-held HTTP request 4 from the client on the STB 2. If there are any changes immediately available, the client on the STB 2 can be notified, however, according to an exemplary embodiment it may be preferable to only provide notification to allow the client on the STB 2 to fetch the data. If no changes are available, the server 6 can enter a wait state. This wait state can be exited if a relevant update is received, or if the long-held HTTP request 4 is about to expire. In the case of the long-held HTTP request 4 expiring, a null notification can be issued, which will cause the client on the STB 2 to issue a new request. If there are any updates, then a notification is issued as before.

According to exemplary embodiments, to determine if a relevant update is available, as well as what element is to be updated, the server 6 determines that a change has been received, and then increments the Version associated with the DataReference. The impact of the change on a child element in the hierarchy can then be examined. If there was no change to lower levels of the hierarchy, only the nodes where such a change is relevant is changed. If the change impacts upper levels in the hierarchy compared to previous changes lower in the hierarchy, all child levels in the hierarchy are updated with newest Version. This process can be iteratively followed so that all levels that are impacted are updated. Clients can then be notified either of a bulk of changes to the software version or as each DataReference is updated. Additionally, controls such as throttling logic can be put in place to control the speed and time of delivery of the updates so that currently viewed applications are not negatively affected by the transferring of the change information.

According to exemplary embodiments, the server side push functions described herein can be designed while considering network performance. For example, the server side push functions can include a configurable option such that the server side push functions can be turned off by an operator as desired. Data updates can be fetched from the nearest HTTP cache. When new data is introduced to the system, e.g., content updates, the portal can use techniques to invalidate the current data in the HTTP cache which ensures that the new data is delivered. This new data can be cached after the first request for the new data and then the new data can be served from the cache to the rest of the STBs 2.

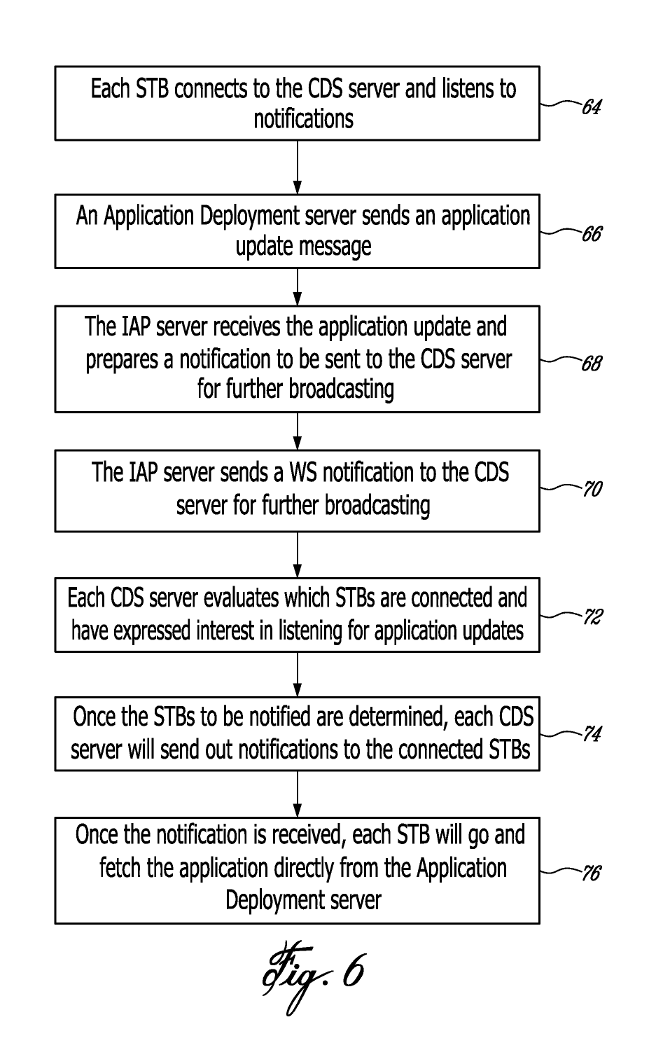

An exemplary use case method for an application update is illustrated in FIG. 6. For this use case, the application deployment update contains a reference to a new application, therefore, there is a need for STBs 2 to go and fetch the new application after receiving the notification. Therein, at step 64, each STB connects to the CDS server and listens to notifications. For this use case, it is assumed that the STB stays connected after start-up for a period of time which can be controlled by the network. At step 66, an Application Deployment server sends an application update message. At step 68, the IAP server receives the application update and prepares a notification to be sent to the CDS server. At step 70, the IAP server sends a WS notification to the CDS server for further broadcasting. All CDS servers will receive the notification. At step 72, each CDS server evaluates which STBs are connected and have expressed interest in listening for application updates.

At step 74, once the STBs to be notified are determined, each CDS server will send out notifications to the connected STBs. At step 76, once the notification is received, each STB will go and fetch the application directly from the Application Deployment server. According to an exemplary embodiment, there can be an IPTV proxy which may cache the new application data (as an optimization) so only the first request from the STB will actually make its way through the IPTV proxy onto the Application Deployment server. All the other STBs will use cached data.

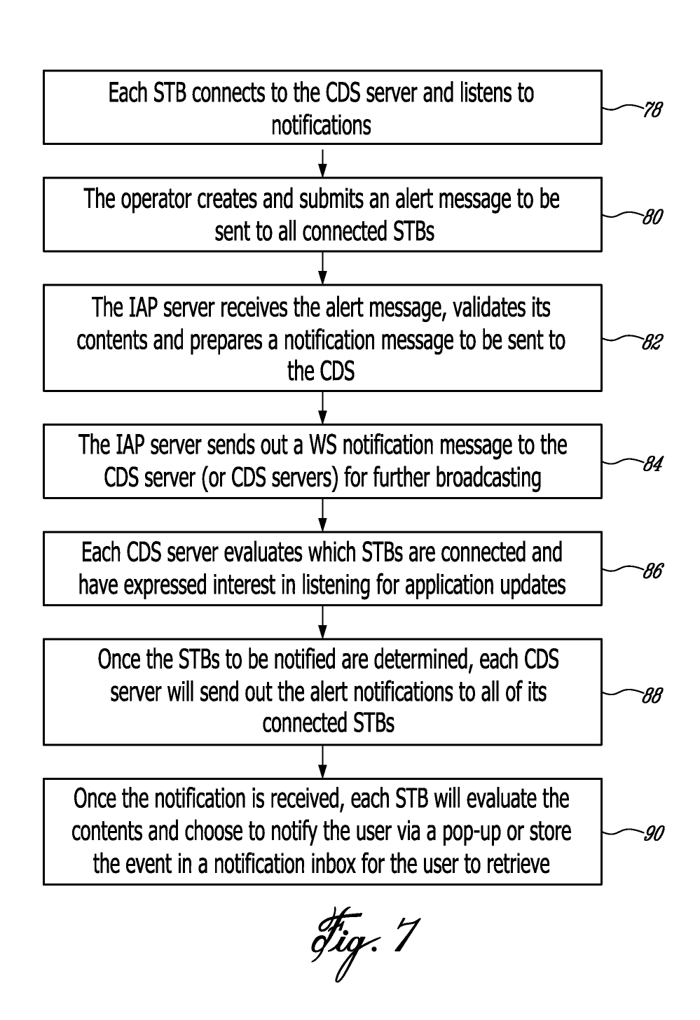

Another exemplary use case method for an application update is illustrated in FIG. 7. This exemplary use case describes sending an alert message with a payload to all connected STBs. For this use case, there is no need for the STBs to go and fetch any information after receiving the notification because the external SI application generates an alert message which includes the payload. Therein, at step 78, each STB connects to the CDS server and listens to notifications. For this case, it is assumed that the STB stays connected after start-up for a period of time which can be controlled by the network. At step 80, the operator creates and submits an alert message to be sent to all connected STBs. At step 82, the IAP server receives the alert message, validates its contents and prepares a notification message to be sent to the CDS.

At step 84, the IAP server sends a WS notification message to the CDS server (or CDS servers) for further broadcasting. At step 86, each CDS server evaluates which STBs are connected and have expressed interest in listening to alert messages. At step 88, once the STBs to be notified are determined, each CDS server will send out the alert notifications to all of its connected STBs. At step 90, once the notification is received, each STB will evaluate the contents and based on, for example, portal implementation, choose to notify the user via a pop-up or store the event in a notification inbox (or equivalent) for the user to retrieve.

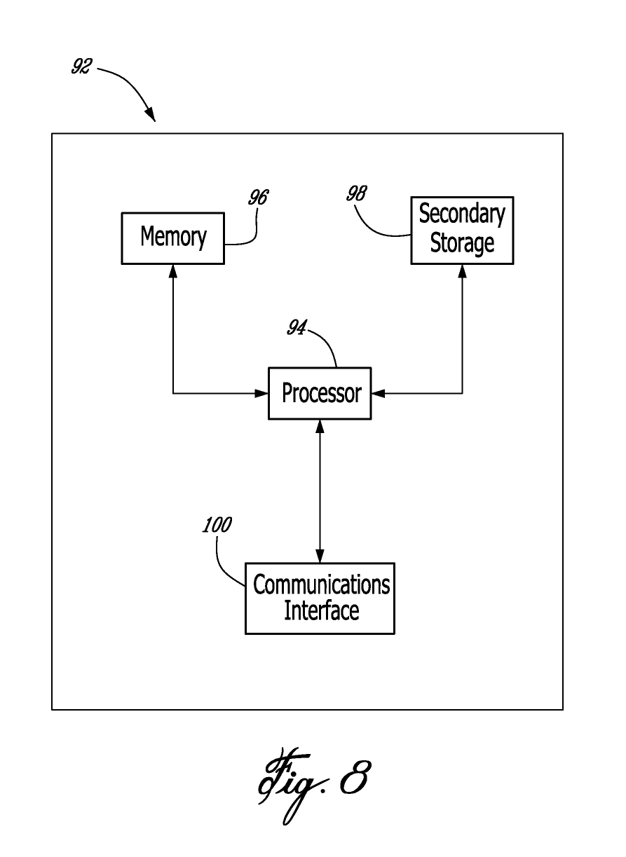

The exemplary embodiments described above provide for the use of push and versioning control mechanisms to deliver content and/or updates to clients on, for example, an STB 2. An exemplary communications node 92, which can be any of the STB 2, the IAP Core WS 6, the CDS server 18, the IAP server 8 and a node which hosts the SI Application 10, will now be described with respect to FIG. 8. The communications node can contain a processor 94 (or multiple processor cores), memory 96, one or more secondary storage devices 98 and an interface unit 100 to facilitate communications between communications nodes, devices, e.g., STB 2 and the various servers described herein. The processor 94 can execute instructions to facilitate the exemplary embodiments described above with respect to the server side push mechanisms described herein. Memory 96 can be used to store information associated with the hierarchies and tables as shown in FIGS. 3-5, as well as, user preferences, e.g., parental controls which can influence notification/update desires. Thus, communications node 92 can perform the exemplary embodiments described herein.

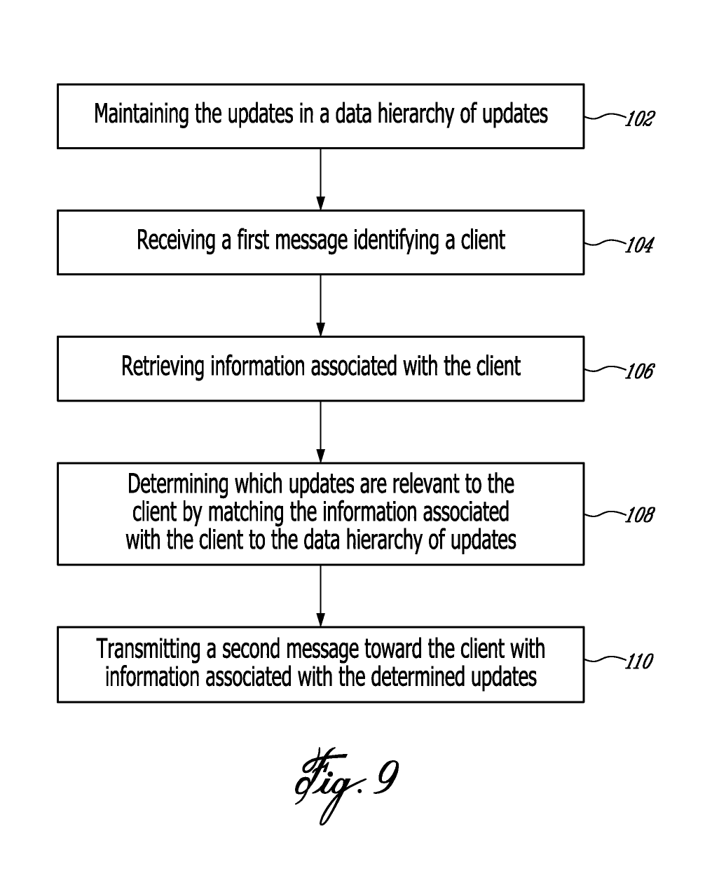

An exemplary method for transmitting updates in an IPTV system towards a client is illustrated in FIG. 9. Therein, at step 102, maintaining the updates in a data hierarchy of updates; at step 104 receiving a first message identifying a client; at step 106 retrieving information associated with the client; at step 108 determining which updates are relevant to the client by matching the information associated with the client to the data hierarchy of updates; and at step 110 transmitting a second message toward the client with information associated with the determined updates.

One skilled in the art will appreciate that through the use of the above described exemplary push and versioning control mechanisms, an operator or IPTV provider can push out alerts/new programs or updates/EPG updates, etc. to one, many or all STBs 2 in a controlled and possibly consolidated fashion. This mechanism can also provide the ability to control and keep track, in an intelligent manner, of the STBs 2 that received particular updates and provide only the necessary updates to those STBs 2 that need them. Furthermore, these mechanisms can be provided through a change at a server 6 and do not need any changes in behavior at the client that would entail reprogramming the STB 2 or other terminal/host device. Thus, the exemplary features described herein can be provided, in some instances, to the user in a transparent manner. The above described systems and methods can provide an IPTV provider the ability to deploy software updates to STBs 2 transparently without having to rely on user-interaction. Additionally, any so-called “house-keeping” operations, e.g., the sending of bulk notifications or software updates, etc., can be performed during off-peak or maintenance hours.

Embodiments of the invention may be represented as a software product stored in a machine-readable medium (also referred to as a computer-readable medium, a processor readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for transmitting updates in an Internet Protocol Television (IPTV) system towards a client, the method comprising:
maintaining the updates in a data hierarchy of updates;
receiving a first message identifying a client;
retrieving information associated with the client;
determining which updates are relevant to the client by matching the information associated with the client to the data hierarchy of updates; and
transmitting a second message toward the client with information associated with the determined updates.

2. The method of claim 1, wherein the first message is a long-held hypertext transport protocol (HTTP) message and is a part of a sequence of messages transmitted when the client initially connects to the IPTV system.

3. The method of claim 1, wherein the first message occurs after the client has connected to the IPTV system and includes additional information for use in determining which updates are relevant to the client.

4. The method of claim 1, further comprising:
transmitting, as the information associated with the determined updates, all of the determined updates toward the client; and
using a throttling logic to control a speed and timing of delivery of all of the determined updates.

5. The method of claim 1, wherein the data hierarchy of updates includes a DataReference and a version which create a data couplet, wherein the DataReference corresponds to a set of available information and the version corresponds to the current version of the DataReference.

6. The method of claim 5, wherein the DataReference is described by a hierarchy which is an ordered list of identifiers which specify what data has changed.

7. The method of claim 5, wherein the DataReference is associated with an electronic program guide for the IPTV environment.

8. The method of claim 1, further comprising:
pulling at least some of the determined updates, by the client, based on the information in the second message.

9. A method for transmitting updates in an Internet Protocol Television (IPTV) system, the method comprising:
receiving a first message which includes information associated with an update;
determining, based on the information associated with the update, an effect to a first data hierarchy;
applying a change to the first data hierarchy based on the effect to the first data hierarchy, which change results in a second data hierarchy which is differentiated from the first data hierarchy by having a different version number;
storing the second data hierarchy and its associated version number;
determining which clients to notify of the change to the first data hierarchy, which results in a subset of clients to receive update information associated with the second data hierarchy; and
transmitting a second message which includes information associated with the second data hierarchy to the subset of clients.

10. The method of claim 9, further comprising:
receiving a third message which is a long-held hypertext transport protocol (HTTP) message and is a part of a sequence of messages transmitted when the client initially connects to the IPTV system.

11. The method of claim 9, further comprising:
transmitting, as the information associated with the second data hierarchy to the subset of clients, all of the updates associated with the second data hierarchy to the subset of clients; and
using a throttling logic to control a speed and timing of delivery of all of the determined updates.

12. The method of claim 9, further comprising:
pulling at least some of the updates associated with the second data hierarchy, by at least one of the clients, based on the second message which includes information associated with the second data hierarchy.

13. A method for receiving updates in an Internet Protocol Television (IPTV) system, the method comprising:
transmitting, from a client, a first message identifying the client, wherein the first message is a long-held hypertext transport protocol (HTTP) message;
receiving a second message, wherein the second message includes a DataReference and a Version for describing available updates for the client; and
storing the DataReference and the Version.

14. The method of claim 13, further comprising:
pulling, by the client, the available updates based on the DataReference and the Version in the second message.

15. The method of claim 13, further comprising:
receiving, at the client, at least some of available updates based on the DataReference and the Version in the second message; and
using a throttling logic to control a speed and timing of delivery of all of the determined updates.

16. A communications node for transmitting updates in an Internet Protocol Television (IPTV) system towards a client, the communications node comprising:
a communications interface for receiving a first message identifying a client;
a memory from which information associated with the client is retrieved and in which a data hierarchy of updates is maintained;
a processor for determining which updates are relevant to the client by matching the information associated with the client to said data hierarchy of updates; and
wherein the communications interface transmits a second message toward the client with information associated with the determined updates.

17. The communications node of claim 16, wherein the first message is a long-held hypertext transport protocol (HTTP) message and is a part of a sequence of messages transmitted when the client initially connects to the IPTV system.

18. The communications node of claim 16, wherein the first message occurs after the client has connected to the IPTV system and includes additional information for use in determining which updates are relevant to the client.

19. The communications node of claim 16, wherein all of the determined updates are transmitted toward the client as the information associated with the determined updates, further wherein a throttling logic is used to control a speed and timing of delivery of all of the determined updates.

20. The communications node of claim 16, wherein the data hierarchy of updates includes a DataReference and a version which create a data couplet, wherein the DataReference corresponds to a set of available information and the version corresponds to the current version of the DataReference.

21. The communications node of claim 20, wherein the DataReference is described by a hierarchy which is an ordered list of identifiers which specify what data has changed.

22. The communications node of claim 16, wherein the DataReference is associated with an electronic program guide for the IPTV environment.

23. The communications node of claim 16, wherein at least some of the determined updates are pulled by the client based on the information in the second message.

24. A communications node for transmitting updates in an Internet Protocol Television (IPTV) system, the communications node comprising:
a communications node for receiving a first message which includes information associated with an update;
a processor for determining, based on the information associated with the update, an effect to a first data hierarchy, wherein the processor also applies a change to the first data hierarchy based on the effect to the first data hierarchy which change results in a second data hierarchy which is differentiated from the first data hierarchy by having a different version number;
a memory for storing the second data hierarchy and its associated version number;
the processor which also is for determining which clients to notify of the change to the first data hierarchy, which results in a subset of clients to receive update information associated with the second data hierarchy; and
wherein the communications interface also is for transmitting a second message which includes information associated with the second data hierarchy to the subset of clients.

25. The communications node of claim 24, wherein the communications interface also receives a third message which is a long-held hypertext transfer protocol (HTTP) message is a part of a sequence of messages transmitted when the client initially connects to the IPTV system.

26. The communications node of claim 24, wherein the communications interface also transmits, as the information associated with the second data hierarchy to the subset of clients, all of the updates associated with the second data hierarchy to the subset of clients, further wherein a throttling logic is used to control a speed and timing of delivery of all of the determined updates.

27. The communications node of claim 25, wherein at least one of the clients pulls at least some of the updates associated with the second data hierarchy, based on the second message which includes information associated with the second data hierarchy.

28. A user equipment (UE) which hosts a client for receiving updates in an Internet Protocol Television (IPTV) environment, the UE comprising:
a communications interface for transmitting a first message identifying the client, wherein the first message is a long-held hypertext (HTTP) message and for receiving a second message, wherein the second message includes a DataReference and a Version for describing available updates for the client; and
a memory for storing the DataReference and the Version.

29. The UE of claim 28, wherein the client pulls the available updates based on the DataReference and the Version in the second message.

30. The UE of claim 28, wherein the UE also receives, as the information associated with the second data hierarchy to the subset of clients, all of the updates associated with the second data hierarchy to the subset of clients, further wherein a throttling logic is used to control a speed and timing of delivery of all of the determined updates.
